(19) United States
(12) Patent Application Publication
(10) Pub. No.: US 2008/0013213 A1
(43) Pub. Date: Jan. 17, 2008

(54) Head, head suspension assembly, and disk device provided with the same

(75) Inventor: Kan Takahashi, Musashino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/819,048

(22) Filed: Jun. 25, 2007

(30) Foreign Application Priority Data
Jun. 30, 2006 (JP) 2006-182688

(51) Int. Cl. G11B 5/60; G11B 15/64; G11B 17/32

(52) U.S. Cl. 360/235.4

(57) ABSTRACT

According to one embodiment, a slider of a head has a negative-pressure cavity which is formed in a facing surface, a leading step portion, a trailing step portion, a pair of side step portions which protrude from the facing surface and extend in the longitudinal direction, and a pair of skirt portions. Each of the skirt portions has a proximal end portion and an extended end portion, which is situated on the downstream end side of the slider and nearer to the trailing step portion with respect to the proximal end portion and faces the trailing step portion with a gap therebetween. The skirt portion is disposed in a region E which contains a line connecting the proximal end portion and the extended end portion and an area situated on the opposite side of the line with respect to the trailing step portion.

### CROSS-REFERENCE TO RELATED APPLICATIONS

This application is based upon and claims the benefit of priority from Japanese Patent Application No. 2006-182688, filed Jun. 30, 2006, the entire contents of which are incorporated herein by reference.

### BACKGROUND

1. Field

One embodiment of the present invention relates to a head used in a disk device, a head suspension assembly provided with the head, and a disk device provided with the head suspension assembly.

2. Description of the Related Art

A disk device, e.g., a magnetic disk device, comprises a magnetic disk, spindle motor, magnetic head, and carriage assembly. The magnetic disk is arranged in a case. The spindle motor supports and rotates the disk. The magnetic head writes and reads information to and from the disk. The carriage assembly supports the head for movement with respect to the disk. The carriage assembly comprises a rockably supported arm and a suspension extending from the arm. The magnetic head is supported on an extended end of the suspension. The head has a slider attached to the suspension and a head portion on the slider. The head portion is constructed including a reproducing element for reading and a recording element for writing.

The slider has an air bearing surface (ABS) that is opposed to a recording surface of the magnetic disk. The air bearing surface is formed with a negative-pressure cavity as a negative-pressure generating portion for generating a negative pressure. A predetermined head load directed to a magnetic recording layer of the disk is applied to the slider by the suspension. When the magnetic disk device is actuated, an airflow is generated between the disk in rotation and the slider. The air bearing surface of the slider is subjected to a positive pressure that is directed opposite to the negative pressure generated by the negative-pressure cavity, that is, a force to fly the slider above the recording surface of the disk. By balancing this flying force with the head load, the slider is flown with a given gap above the recording surface of the disk.

The flying height of the slider is expected to be substantially fixed without regard to the radial position of the magnetic disk. The rotational frequency of the disk is constant, while its peripheral speed varies depending on the radial position. Since the magnetic head is positioned by the rotary carriage assembly, moreover, a yaw angle (angle between the direction of the flow (track direction) and the center line of the slider) also varies depending on the radial position of the disk. In designing the slider, therefore, change of the flying height based on the radial position of the disk must be suppressed by suitably utilizing the aforesaid two parameters that vary depending on the radial position of the disk.

In recent years, furthermore, sliders have been reduced in size with the improvement of recording density, and studies have been conducted on so-called pico sliders, femto sliders, etc. If a slider is miniaturized so that its transverse dimension is small, its swing or roll oscillation around its longitudinal axis occurs more easily when it is subjected to external shock.

In order to suppress such roll oscillation, a head is proposed which is provided with a pair of side pads extending parallel to the longitudinal axis of a slider on its air bearing surface (e.g., Jpn. Pat. Appln. KOKAI Publication No. 2005-18985). These side pads are disposed individually on the opposite sides of the slider axis and serve to enhance the roll stiffness of the slider, thereby suppressing the occurrence of roll oscillation.

The roll stability of the slider cannot be satisfactorily improved by only suppressing the occurrence of roll oscillation. If roll oscillation occurs, it must be damped quickly. In the case of a small-sized head with a small air bearing surface, as mentioned before, roll oscillation is easily caused by disturbance, so that the roll stability is expected to be further improved.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view showing an HDD according to a first embodiment of the invention;

FIG. 2 is an exemplary enlarged side view showing a magnetic head portion of the HDD;

FIG. 3 is an exemplary perspective view showing the disk-facing surface side of a slider of the magnetic head;

FIG. 4 is an exemplary plan view showing the disk-facing surface side of the slider;

FIG. 5 is an exemplary side view showing the slider;

FIGS. 6A, 6B and 6C are exemplary plan views schematically showing sliders according to Comparative Examples;

FIG. 7 is an exemplary diagram comparatively showing damping force against roll oscillation for the slider according to the first embodiment and the sliders according to Comparative Examples;

FIG. 8 is an exemplary plan view showing a slider of a magnetic head according to a second embodiment of the invention;

FIG. 9 is an exemplary diagram comparatively showing damping force against roll oscillation for the sliders according to the first and second embodiments and the sliders according to Comparative Examples;

FIG. 10 is an exemplary plan view showing a slider of a magnetic head according to a third embodiment of the invention;

FIG. 11 is an exemplary plan view showing a slider of a magnetic head according to a fourth embodiment of the invention; and

FIG. 12 is an exemplary plan view showing a slider of a magnetic head according to a fifth embodiment of the invention.

### DETAILED DESCRIPTION

Various embodiments according to the invention will be described hereinafter with reference to the accompanying drawings. In general, according to one embodiment of the invention, there is provided a head comprising: a slider which has a facing surface opposed to a surface of a rotatable recording medium and is flown by an airflow which is generated between a surface of the recording medium and the facing surface as the recording medium rotates; and a head portion which is provided on the slider and records and reproduces information to and from the recording medium, the facing surface of the slider having a longitudinal direction extending in a direction of the airflow and a transverse direction perpendicular to the longitudinal direction, the slider having a negative-pressure cavity which is formed in the facing surface and generates a negative pressure, a leading step portion which protrudes from the facing surface and is situated on an upstream side of the negative-pressure cavity with respect to the airflow, a trailing step portion which protrudes from the facing surface, is situated on a downstream side of the negative-pressure cavity with respect to the airflow, and faces the recording medium, a pair of side step portions which protrude from the facing surface, extend in the longitudinal direction from the leading step portion toward a downstream end of the slider, and face each other with a gap in the transverse direction therebetween, and a pair of skirt portions which protrude from the facing surface and extend individually from the side step portions toward the downstream end of the slider, each of the skirt portions having a proximal end portion connected to each corresponding side step portion and an extended end portion, which is situated on the downstream end side of the slider and nearer to the trailing step portion with respect to the proximal end portion and faces the trailing step portion with a gap therebetween, and being disposed in a region which contains a line connecting the proximal end portion and the extended end portion and an area situated on the opposite side of the line with respect to the trailing step portion.

According to another embodiment of the invention, there is provided a disk device comprising: a disk-shaped recording medium; a drive section which supports and rotates the recording medium; a head including a slider which has a facing surface opposed to a surface of the recording medium and is flown by an airflow which is generated between the recording medium surface and the facing surface as the recording medium rotates, and a head portion which is provided on the slider and records and reproduces information to and from the recording medium; and a head suspension which supports the head for movement with respect to the recording medium and applies a head load directed to a surface of the recording medium to the head. The facing surface of the slider has a longitudinal direction extending in a direction of the airflow and a transverse direction perpendicular to the longitudinal direction, the slider has a negative-pressure cavity which is formed in the facing surface and generates a negative pressure, a leading step portion which protrudes from the facing surface and is situated on an upstream side of the negative-pressure cavity with respect to the airflow, a trailing step portion which protrudes from the facing surface, is situated on a downstream side of the negative-pressure cavity with respect to the airflow, and faces the recording medium, a pair of side step portions which protrude from the facing surface, extend in the longitudinal direction from the leading step portion toward a downstream end of the slider, and face each other with a gap in the transverse direction therebetween, and a pair of skirt portions which protrude from the facing surface and extend individually from the side step portions toward the downstream end of the slider. Each of the skirt portions has a proximal end portion connected to each corresponding side step portion and an extended end portion, which is situated on the downstream end side of the slider and nearer to the trailing step portion with respect to the proximal end portion and faces the trailing step portion with a gap therebetween, and being disposed in a region which contains a line connecting the proximal end portion and the extended end portion and an area situated on the opposite side of the line with respect to the trailing step portion.

A first embodiment in which a disk device according to this invention is applied to a hard disk drive (HDD) will now be described in detail with reference to the accompanying drawings.

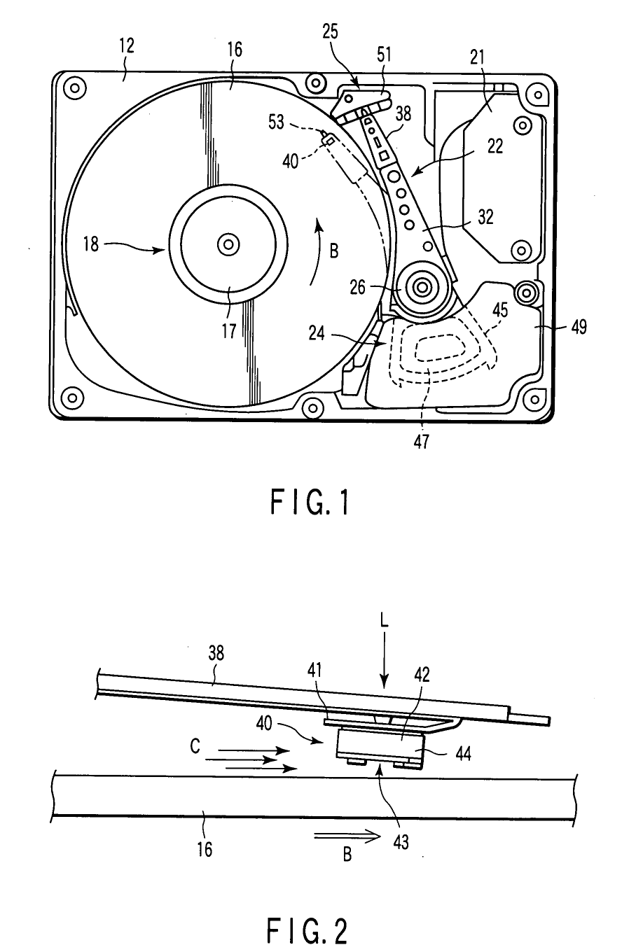

FIG. 1 is a plan view showing the internal structure of the HDD with its top cover removed, and FIG. 2 shows a magnetic head in a flying state. As shown in FIG. 1, the HDD has a case 12 in the form of an open-topped rectangular box and the top cover (not shown). The top cover is fastened to the case by screws so as to close a top opening of the case.

The case 12 contains a magnetic disk 16, spindle motor 18, magnetic heads 40, carriage assembly 22, voice coil motor (VCM) 24, ramp load mechanism 25, board unit 21, etc. The magnetic disk 16 serves as a recording medium. The spindle motor 18 serves as a drive section that supports and rotates the magnetic disk. The magnetic heads write and read information to and from the disk. The carriage assembly 22 supports the heads for movement with respect to the disk 16. The VCM 24 rocks and positions the carriage assembly. The ramp load mechanism 25 holds the magnetic heads in a retracted position at a distance from the magnetic disk when the heads are moved to the outermost periphery of the disk. The board unit 21 has a head IC and the like.

A printed circuit board (not shown) for controlling the operations of the spindle motor 18, VCM 24, and magnetic heads through the board unit 21 is screwed to the outer surface of a bottom wall of the case 12.

The magnetic disk 16 has magnetic recording layers on its upper and lower surfaces, individually. The disk 16 is fitted on a hub (not shown) of the spindle motor 18 and fixed on the hub by a clamp spring 17. If the motor 18 is actuated, the disk 16 is rotated at a predetermined speed of, for example, 4,200 rpm in the direction of arrow B.

The carriage assembly 22 is provided with a bearing portion 26 fixed on the bottom wall of the case 12 and arms 32 extending from the bearing portion. The arms 32 are situated parallel to the surfaces of the magnetic disk 16 and spaced from one another. They extend in the same direction from the bearing portion 26. The carriage assembly 22 is provided with suspensions 38 that are elastically deformable elongate plates. Each suspension 38 is formed of a leaf spring, of which the proximal end is fixed to the distal end of its corresponding arm 32 by welding or adhesive bonding and which extends from the arm. Alternatively, each suspension may be formed integrally with its corresponding arm 32. The arm 32 and the suspension 38 constitute a head suspension, and the head suspension and the magnetic heads 40 constitute a head suspension assembly.

As shown in FIG. 2, each magnetic head 40 has a slider 42 substantially in the shape of a rectangular parallelepiped and a recording/reproducing head portion 44 on the slider. It is fixed to a gimbals spring 41 that is provided on the distal end portion of each suspension 38. Each magnetic head 40 is subjected to a head load L directed to a surface of the magnetic disk 16 by the elasticity of the suspension 38.

As shown in FIG. 1, the carriage assembly 22 has a support frame 45 extending from the bearing portion 26 in the direction opposite from the arms 32. The support frame supports a voice coil 47 that constitutes a part of the VCM 24. The support frame 45 is molded from plastic and formed integrally on the outer periphery of the voice coil 47. The voice coil 47 is situated between a pair of yokes 49 that are fixed on the case 12 and, in conjunction with these yokes and a magnet (not shown) fixed to one of the yokes, constitutes the VCM 24. If the voice coil 47 is energized, the carriage assembly 22 rocks around the bearing portion 26, whereupon each magnetic head 40 is moved to and positioned in a region over a desired track of the magnetic disk 16.

The ramp load mechanism 25 comprises a ramp 51 and tabs 53. The ramp 51 is provided on the bottom wall of the case 12 and located outside the magnetic disk 16. The tabs 53 extend individually from the respective distal ends of the suspensions 38. As the carriage assembly 22 rocks to its retracted position outside the magnetic disk 16, each tab 53 engages a ramp surface on the ramp 51 and is then pulled up along the slope of the ramp surface, whereupon each magnetic head is unloaded.

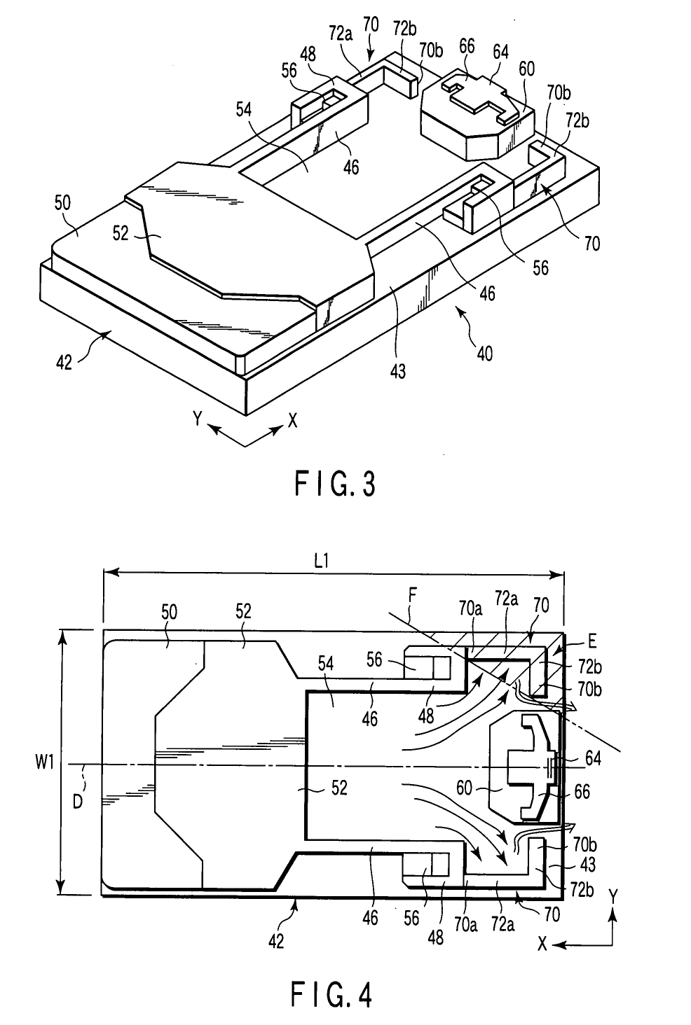

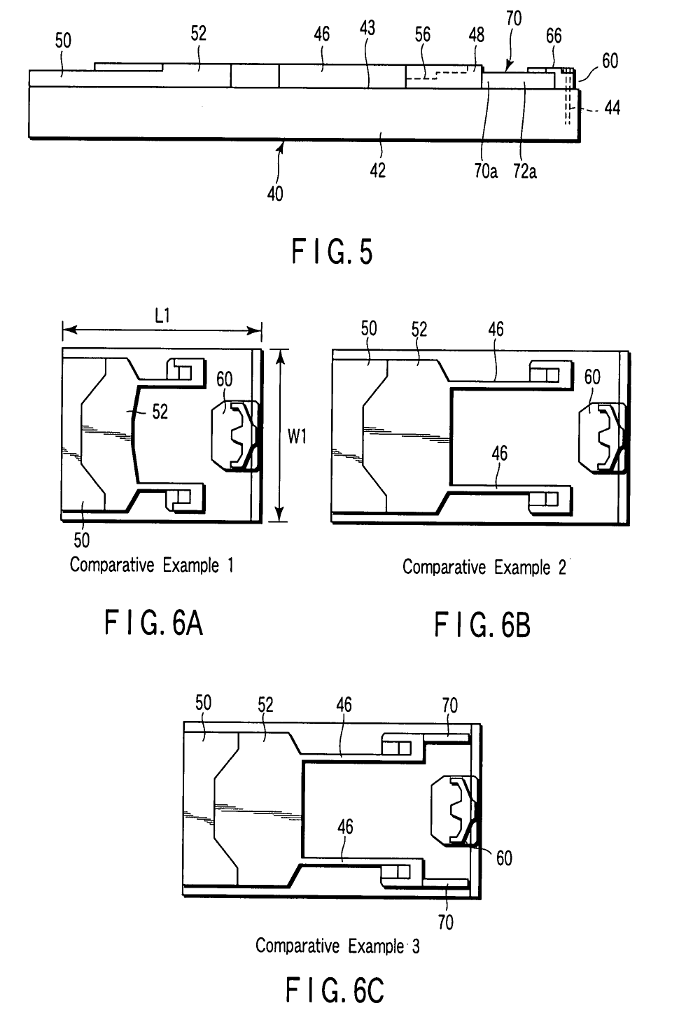

The following is a detailed description of each magnetic head 40. FIG. 3 is a perspective view showing the slider of the magnetic head, FIG. 4 is a plan view of the slider, and FIG. 5 is a side view of the slider.

As shown in FIGS. 3 to 5, the magnetic head 40 has the slider 42 that is substantially in the shape of a rectangular parallelepiped. The slider 42 has a rectangular disk-facing surface (air bearing surface (ABS)) 43, which faces a surface of the magnetic disk 16. The longitudinal direction of the disk-facing surface 43 is supposed to be a first direction X, and the transverse direction perpendicular thereto to be a second direction Y. The disk-facing surface 43 has a central axis D that extends in the first direction X.

The slider 42 is formed as a so-called pemto slider, having a length L of 1.25 mm, in the first direction X and a width W of 0.7 mm or less, in the second direction Y.

The magnetic head 40 is constructed as a flying head, in which the slider 42 is flown by an airflow C (see FIG. 2) that is generated between the disk surface and the disk-facing surface 43 as the magnetic disk 16 rotates. When the HDD is operating, the disk-facing surface 43 of the slider 42 never fails to be opposed to the disk surface with a gap therebetween. The direction of the airflow C is coincident with the rotation direction B of the magnetic disk 16. The slider 42 is located so that the first direction X of the disk-facing surface 43 opposed to the surface of the disk 16 is substantially coincident with the direction of the airflow C.

A substantially rectangular leading step portion 50 protrudes from the disk-facing surface 43 so as to face the magnetic disk surface. A pair of side step portions 46 protrude from the disk-facing surface 43. They extend along the long sides of the surface 43 and are opposed to each other with a space between them. The side step portions 46 extend from the leading step portion 50 toward the downstream end of the slider 42. The leading step portion 50 and the pair of side step portions 46 are located symmetrically with respect to the central axis D of the slider 42. As a whole, they are formed substantially in the shape of a U, closed on the upstream side and open to the downstream side.

In order to maintain the pitch angle of the magnetic head 40, a leading pad 52 that utilizes an air film to support the slider 42 protrudes from the leading step portion 50. The leading pad 52 continuously extends throughout the area in the width direction of the leading step portion 50 in the second direction Y, and is formed in a position deviated on the downstream side from the inflow end of the slider 42. The leading pad 52 is situated on the inflow end side of the slider 42 with respect to the direction of the airflow C. A side pad 48 is formed on each side step portion 46 and leads to the leading pad 52. The pads 52 and 48 are formed substantially flat and face the magnetic disk surface.

A recess 56 is formed in each side pad 48. The recess 56 opens toward the inflow end of the disk-facing surface 43 as well as toward the magnetic disk surface. Each recess 56 has a rectangular shape defined by a pair of side edges, which extend substantially parallel to the first direction X, and a bottom edge, which connects the respective extended ends of the side edges and extends substantially parallel to the second direction Y.

As shown in FIGS. 3 and 4, a negative-pressure cavity 54 is formed substantially in the center of the disk-facing surface 43. It is a recess that is defined by the pair of side step portions 46 and the leading step portion 50. The cavity 54 is formed on the downstream side of the leading step portion 50 with respect to the direction of the airflow C and opens toward the downstream side. The negative-pressure cavity 54 serves to produce a negative pressure on the central part of the disk-facing surface 43 at all feasible yaw angles for the HDD.

The slider 42 has a substantially rectangular trailing step portion 60 that protrudes from the downstream end portion of the disk-facing surface 43. The trailing step portion 60 is situated on the downstream side of the negative-pressure cavity 54 with respect to the direction of the airflow C and substantially in the center of the disk-facing surface 43 with respect to the transverse direction thereof. A trailing pad 66 protrudes from the trailing step portion 60 and faces the magnetic disk surface.

The head portion 44 of the magnetic head 40 has a recording element and a reproducing element, which record and reproduce information to and from the magnetic disk 16. The reproducing and recording elements are embedded in the downstream end portion of the slider 42 with respect to the direction of the airflow C. The reproducing and recording elements have a read/write gap 64 that is formed in the trailing pad 66.

As shown in FIGS. 3 to 5, the slider 42 has a pair of skirt portions 70 that individually protrude from the disk-facing surface 43. The skirt portions 70 are located symmetrically with respect to the central axis D of the slider 42. The skirt portions 70 extend individually from the side step portions 46 toward the downstream end of the slider 42. Each skirt portion 70 has a proximal end portion 70a connected to each corresponding side step portion 46 and an extended end portion 70b situated on the downstream end side of the slider 42 and nearer to the trailing step portion 60 with respect to the proximal end portion. The extended end portion 70b faces the trailing step portion 60 with a gap therebetween.

On the disk-facing surface 43, as shown in FIG. 4, each skirt portion 70 is disposed in a region E that contains a line F connecting the proximal end portion 70a and the extended end portion 70b and an area situated on the opposite side of the line with respect to the trailing step portion 60.

In the present embodiment, each skirt portion 70 has a first portion 72a and a second portion 72b and is substantially L-shaped. The first portion 72a extends in the first direction X of the disk-facing surface 43 from the proximal end portion 70a toward the downstream end of the slider 42. The second portion 72b extends in the second direction Y of the disk-facing surface from the first portion to the extended end portion 70b. The height of projection of each skirt portion 70 above the disk-facing surface 43 is lower than that of each side step portion 46.

According to the HDD and the head suspension assembly constructed in this manner, the magnetic head 40 is flown by the airflow C that is generated between the disk surface and the disk-facing surface 43 as the magnetic disk 16 rotates. When the HDD is operating, the disk-facing surface 43 of the slider 42 never fails to be opposed to the disk surface with a gap therebetween. As shown in FIG. 2, the magnetic head 40 flies in an inclined posture such that the read/write gap 64 of the head portion 44 is located closest to the disk surface.

According to the magnetic head 40 constructed in this manner, a negative pressure can be stably generated by the negative-pressure cavity 54 that is provided in the central part of the disk-facing surface 43. The roll stiffness of the slider 42 is enhanced by the side step portions 46 on the opposite sides of the central axis D of the slider, so that occurrence of roll oscillation, i.e., oscillation around the central axis D of the slider, can be suppressed. Further, the pair of substantially L-shaped skirt portions 70 serve to enhance a damping force against roll oscillation. With use of the skirt portions 70 constructed in this manner, therefore, the airflow that is introduced through the inflow end of the slider 42 and urged to get out through the outflow end is temporarily stopped by the skirt portions. Thereafter, the airflow gets out from the downstream end of the slider through the gaps between the trailing step portion 60 and the respective extended end portions 70b of the skirt portions. Thereupon, a squeezing effect is enhanced, and a damping force in the rolling direction increases.

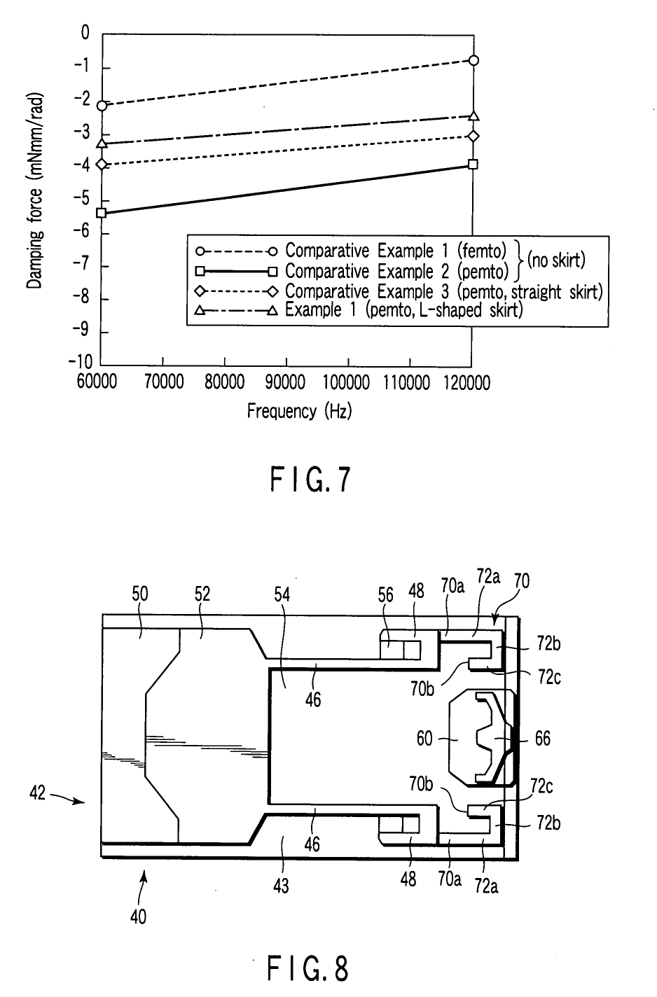

A femto slider of Comparative Example 1 and pemto sliders of Comparative Examples 2 and 3, which are shown in FIG. 6, and the pemto slider according to the first embodiment (Example 1) were prepared and compared for the damping force against roll oscillation. The femto slider of Comparative Example 1 has a length L1 of 0.85 mm in the first direction and a width W1 of 0.7 mm in the second direction and is not provided with any skirt portions. The pemto slider of Comparative Example 2 has no skirt portions. The pemto slider of Comparative Example 3 has skirt portions 70 that extend straight along the longitudinal direction of the slider from side step portions, individually. These sliders share in common other configurations than the skirt portions. FIG. 7 shows results of the comparison.

As seen from FIG. 7, the femto slider (Comparative Example 1) exhibits the highest damping force, while the pemto slider (Comparative Example 2) with no skirt portions displays the lowest damping force. Out of the pemto sliders, the slider (Comparative Example 3) having the straight skirt portions is higher in damping force against roll oscillation than the slider (Comparative Example 2) with no skirt portions. Further, the damping force of the slider (Example 1) with the L-shaped skirt portions according to the present embodiment is higher than that of Comparative Example 3 and approximate to that of the femto slider (Comparative Example 1).

Thus, there may be obtained the magnetic head 40, which is improved in roll stability and can perform information processing for magnetic disks with high reliability and stability, and the head suspension assembly and the HDD provided with the magnetic head.

The following is a description of a magnetic head 40 of an HDD according to a second embodiment of the invention.

As shown in FIG. 8, a pair of skirt portions 70 that protrude from a disk-facing surface 43 of a slider 42 are substantially U-shaped. More specifically, each skirt portion 70 extends from a side step portion 46 toward the downstream end of the slider 42 and a trailing step portion 60.

Each skirt portion 70 has a first portion 72a, a second portion 72b, and a third portion 72c and is substantially L-shaped. The first portion 72a extends in the first direction X of the disk-facing surface 43 from a proximal end portion 70a toward the downstream end of the slider 42. The second portion 72b extends in the second direction Y of the disk-facing surface from the first portion to the vicinity of the trailing step portion 60. The third portion 72c extends in the first direction X from the distal end of the second portion 72b toward the upstream end of the slider. The third portion 72c faces the trailing step portion 60 with a gap therebetween. The height of projection of each skirt portion 70 above the disk-facing surface 43 is lower than that of each side step portion 46.

Since other configurations of the magnetic head 40 and the HDD are the same as those of the foregoing first embodiment, like reference numerals are used to designate like portions, and a detailed description of those portions is omitted.

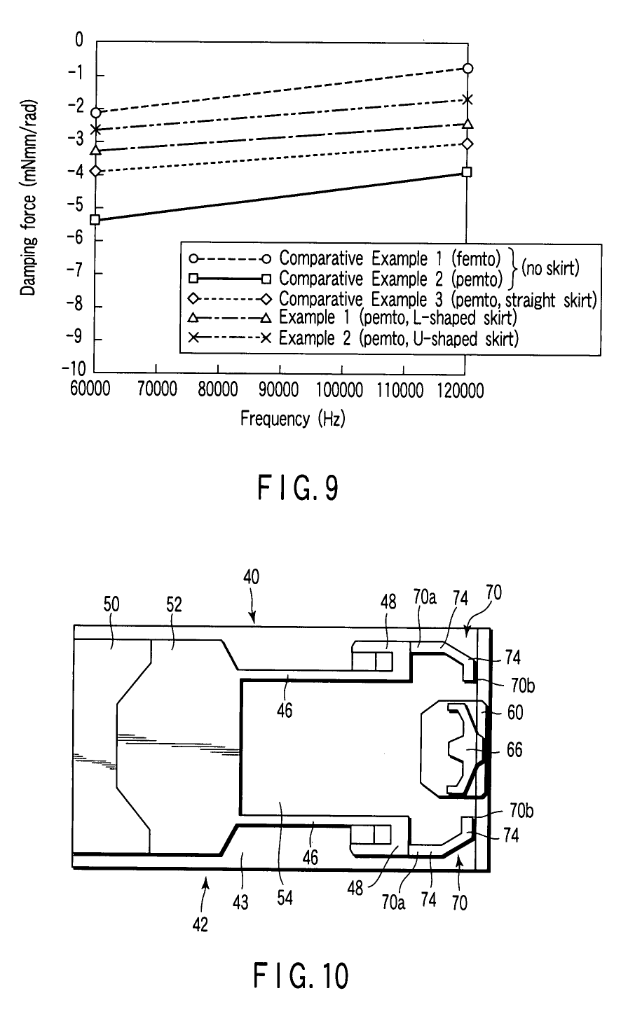

FIG. 9 shows results of comparison of the damping force against roll oscillation between the foregoing sliders according to Comparative Examples 1, 2 and 3 and the first and second embodiments. As seen from FIG. 9, the substantially U-shaped skirt portions 70 produce a damping force higher than that of the slider according to the first embodiment.

The shapes of the skirt portions 70 of the sliders are not limited to the ones according to the first and second embodiments, but may be variously changed within a range that meets the aforementioned conditions. Specifically, it is necessary only that each skirt portion 70 have a proximal end portion connected to each corresponding side step portion 46 and an extended end portion, which is situated on the downstream end side of the slider 42 and nearer to the trailing step portion 60 with respect to the proximal end portion and faces the trailing step portion 60 with a gap therebetween. On the disk-facing surface 43, moreover, each skirt portion 70 is expected only to be disposed in the region E that is situated on the opposite side of the line F that connects the proximal end portion and the extended end portion with respect to the trailing step portion 60.

According to a third embodiment shown in FIG. 10, each skirt portion 70 has a plurality of bent portions 74 that are situated between a proximal end portion 70a and an extended end portion 70b.

According to a fourth embodiment shown in FIG. 11, each skirt portion 70 extends straight from a proximal end portion 70a to an extended end portion 70b and with an inclination to the first direction X of a slider 42.

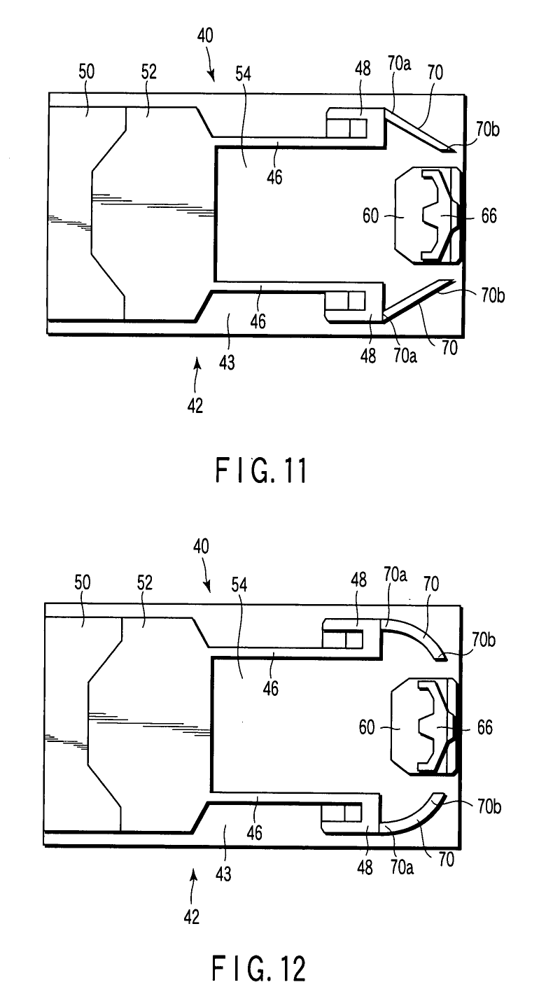

According to a fifth embodiment shown in FIG. 12, each skirt portion 70 extends in an arc from a proximal end portion 70a to an extended end portion 70b.

Since other configurations of magnetic heads and HDDs according to the third to fifth embodiments are the same as those of the foregoing first embodiment, like reference numerals are used to designate like portions, and a detailed description of those portions is omitted. Further, the third to fifth embodiments can provide the same functions and effects as those of the first embodiment.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

This invention is not limited to femto sliders but may be also applied to pico sliders, pemto sliders, or any other larger sliders.

What is claimed is:

1. A head comprising:
a slider which has a facing surface opposed to a surface of a rotatable recording medium and is flown by an airflow which is generated between a surface of the recording medium and the facing surface as the recording medium rotates; and
a head portion which is provided on the slider and records and reproduces information to and from the recording medium,
the facing surface of the slider having a longitudinal direction extending in a direction of the airflow and a transverse direction perpendicular to the longitudinal direction,
the slider having a negative-pressure cavity which is formed in the facing surface and generates a negative pressure, a leading step portion which protrudes from the facing surface and is situated on an upstream side of the negative-pressure cavity with respect to the airflow, a trailing step portion which protrudes from the facing surface, is situated on a downstream side of the negative-pressure cavity with respect to the airflow, and faces the recording medium, a pair of side step portions which protrude from the facing surface, extend in the longitudinal direction from the leading step portion toward a downstream end of the slider, and face each other with a gap in the transverse direction therebetween, and a pair of skirt portions which protrude from the facing surface and extend individually from the side step portions toward the downstream end of the slider,
each of the skirt portions having a proximal end portion connected to each corresponding side step portion and an extended end portion, which is situated on the downstream end side of the slider and nearer to the trailing step portion with respect to the proximal end portion and faces the trailing step portion with a gap therebetween, and being disposed in a region which contains a line connecting the proximal end portion and the extended end portion and an area situated on the opposite side of the line with respect to the trailing step portion.

2. The head according to claim 1, wherein the pair of skirt portions have a height of projection lower than that of the side step portions.

3. The head according to claim 1, wherein each of the skirt portions has a first portion which extends in the longitudinal direction of the facing surface from the proximal end portion toward the downstream end of the slider and a second portion which extends in the transverse direction of the facing surface from the first portion to the extended end portion.

4. The head according to claim 1, wherein each of the skirt portions has a first portion which extends in the longitudinal direction of the facing surface from the proximal end portion toward the downstream end of the slider, a second portion which extends in the transverse direction of the facing surface from the first portion toward the trailing step portion, and a third portion which extends in the longitudinal direction of the facing surface from an extended end of the second portion to the extended end portion.

5. The head according to claim 1, wherein each of the skirt portions extends straight from the proximal end portion to the extended end portion.

6. The head according to claim 1, wherein each of the skirt portions extends in an arc from the proximal end portion to the extended end portion.

7. The head according to claim 1, wherein each of the skirt portions has at least one bent portion situated between the proximal end portion and the extended end portion.

8. The head according to claim 1, wherein the facing surface of the slider has a central axis extending in the longitudinal direction, the pair of side step portions are located symmetrically with respect to the central axis, and the pair of skirt portions are located symmetrically with respect to the central axis.

9. The head according to claim 1, wherein a length of the slider in the longitudinal direction is 1.25 mm or less, and a width of the slider in the transverse direction is 0.7 mm or less.

10. A head suspension assembly used in a disk device which includes a disk-shaped recording medium and a drive section which supports and rotates the recording medium, the head suspension assembly comprising:
a head including a slider which has a facing surface opposed to a surface of the recording medium and is flown by an airflow which is generated between the recording medium surface and the facing surface as the recording medium rotates, and a head portion which is provided on the slider and records and reproduces information to and from the recording medium; and
a head suspension which supports the head for movement with respect to the recording medium and applies a head load directed to a surface of the recording medium to the head,
the facing surface of the slider having a longitudinal direction extending in a direction of the airflow and a transverse direction perpendicular to the longitudinal direction,
the slider having a negative-pressure cavity which is formed in the facing surface and generates a negative pressure, a leading step portion which protrudes from the facing surface and is situated on an upstream side of the negative-pressure cavity with respect to the airflow, a trailing step portion which protrudes from the facing surface, is situated on a downstream side of the negative-pressure cavity with respect to the airflow, and faces the recording medium, a pair of side step portions which protrude from the facing surface, extend in the longitudinal direction from the leading step portion toward a downstream end of the slider, and face each other with a gap in the transverse direction therebetween, and a pair of skirt portions which protrude from the facing surface and extend individually from the side step portions toward the downstream end of the slider,
each of the skirt portions having a proximal end portion connected to each corresponding side step portion and an extended end portion, which is situated on the downstream end side of the slider and nearer to the trailing step portion with respect to the proximal end portion and faces the trailing step portion with a gap therebetween, and being disposed in a region which contains a line connecting the proximal end portion and the extended end portion and an area situated on the opposite side of the line with respect to the trailing step portion.

11. A disk device comprising:
a disk-shaped recording medium;
a drive section which supports and rotates the recording medium;
a head including a slider which has a facing surface opposed to a surface of the recording medium and is flown by an airflow which is generated between the recording medium surface and the facing surface as the recording medium rotates, and a head portion which is provided on the slider and records and reproduces information to and from the recording medium; and
a head suspension which supports the head for movement with respect to the recording medium and applies a head load directed to a surface of the recording medium to the head,
the facing surface of the slider having a longitudinal direction extending in a direction of the airflow and a transverse direction perpendicular to the longitudinal direction,
the slider having a negative-pressure cavity which is formed in the facing surface and generates a negative pressure, a leading step portion which protrudes from the facing surface and is situated on an upstream side of the negative-pressure cavity with respect to the airflow, a trailing step portion which protrudes from the facing surface, is situated on a downstream side of the negative-pressure cavity with respect to the airflow, and faces the recording medium, a pair of side step portions which protrude from the facing surface, extend in the longitudinal direction from the leading step portion toward a downstream end of the slider, and face each other with a gap in the transverse direction therebetween, and a pair of skirt portions which protrude from the facing surface and extend individually from the side step portions toward the downstream end of the slider,
each of the skirt portions having a proximal end portion connected to each corresponding side step portion and an extended end portion, which is situated on the downstream end side of the slider and nearer to the trailing step portion with respect to the proximal end portion and faces the trailing step portion with a gap therebetween, and being disposed in a region which contains a line connecting the proximal end portion and the extended end portion and an area situated on the opposite side of the line with respect to the trailing step portion.
